(19) United States
(12) Patent Application Publication
(10) Pub. No.: US 2014/0258584 A1
(43) Pub. Date: Sep. 11, 2014

(54) BUS RELAY APPARATUS, INTEGRATED CIRCUIT APPARATUS, CABLE, CONNECTOR, ELECTRONIC APPLIANCE, AND BUS RELAY METHOD

(71) Applicant: SEIKO EPSON CORPORATION, Tokyo (JP)

(72) Inventor: Takuya ISHIDA, Sapporo-shi (JP)

(73) Assignee: SEIKO EPSON CORPORATION, Tokyo (JP)

(21) Appl. No.: 14/187,938

(22) Filed: Feb. 24, 2014

(30) Foreign Application Priority Data
Mar. 11, 2013 (JP) 2013-047612

(51) Int. Cl. G06F 13/40

(52) U.S. Cl. CPC G06F 13/4063
USPC 710/313

(57) ABSTRACT

A bus relay apparatus includes: an upstream port unit to which a USB host is connected; a downstream port unit to which a USB device is connected; an upstream port control unit; a downstream port control unit; and a relay unit configured to relay a packet transferred between the upstream port unit and the downstream port unit. In the bus relay apparatus, the downstream port unit reproduces a bus status detected by the upstream port unit and transmits the bus status, and the upstream port unit reproduces a bus status detected by the downstream port unit and transmits the bus status.

### CROSS-REFERENCE TO RELATED APPLICATIONS

This application claims priority to Japanese Patent Application No. 2013-047612 filed on Mar. 11, 2013.

The entire disclosure of Japanese Patent Application No. 2013-047612 is hereby incorporated herein by reference.

### BACKGROUND

1. Technical Field

The present invention relates to a bus relay apparatus, an integrated circuit apparatus, a cable, a connector, an electronic appliance, and a bus relay method.

2. Related Art

Conventionally, the Universal Serial Bus (USB) standard is widely used as an interface standard for connecting personal computers and peripheral devices. The USB standard defines connection between one host and a plurality of devices. The personal computers have, for example, a host function specified by the USB standard, and the peripheral devices have, for example, a device function specified by the USB standard. Hereinafter, a device having the host function specified by the USB standard will be referred to as a “USB host”, and a device having the device function specified by the USB standard will be referred to as a “USB device”.

FIG. 16 shows an example of a configuration of a commonly used communication system including a USB host and a USB device.

This communication system 10 includes a USB host 20 and a USB device 30, and the USB host 20 and the USB device 30 are connected via a bus 40 specified by the USB standard. To be specific, the USB host 20 includes a downstream port unit 22, and one end of the bus 40 is connected to the downstream port unit 22. The USB device 30 includes an upstream port unit 32, and the other end of the bus 40 is connected to the upstream port unit 32. The downstream port unit 22 and the upstream port unit 32 each include, for example, a driver, a receiver, a Non-Return-to-Zero-Inversion (NRZI) decoder/encoder, a synchronous detection circuit, and a squelch detection circuit that are specified by the USB 2.0 standard.

With this configuration, the USB host 20 and the USB device 30 perform half duplex communication specified by the USB standard via the bus 40. At this time, depending on the properties, communication environment and the like of the device to communicate with, the waveform of a signal from the USB host 20 may be distorted on the receiving side, namely, the USB device 30, or the waveform of a signal from the USB device 30 may be distorted on the receiving side, namely, the USB host 20. In FIG. 16, such distorted states in which the signals are distorted on the receiving side are schematically indicated by an eye pattern. In this case, a reception error occurs on the receiving side, and thus the USB host 20 and the USB device 30 cannot communicate with each other.

One approach to solve the above problem is to provide a USB hub having a hub function specified by the USB standard between the USB host 20 and the USB device 30. With the USB hub, the distorted signal waveform is shaped, allowing better communication between the USB host 20 and the USB device 30. Such a technique for USB hubs is disclosed in, for example, JP-A-2011-186791.

However, if a USB hub as disclosed in, for example, JP-A-2011-186791 is provided between the USB host 20 and the USB device 30, the USB host 20 additionally requires to perform control for the USB hub specified by the USB standard. This causes problems such as increasing the number of constituent elements of the communication system including the USB host 20 and the USB device 30, adding complexity to control, and an increase in the cost caused by the above factors.

### SUMMARY

An advantage of some aspects of the invention is to provide a bus relay apparatus, an integrated circuit apparatus, a cable, a connector, an electronic appliance, and a bus relay method that eliminate the need for a USB host to perform unnecessary control such as control on a USB hub and that enable communication between the USB host and a USB device with a simpler configuration.

(1) A bus relay apparatus according to an aspect of the invention includes: an upstream port unit to which a USB host is connected; a downstream port unit to which a USB device is connected; an upstream port control unit configured to control the upstream port unit; a downstream port control unit configured to control the downstream port unit; and a relay unit configured to relay a packet transferred between the upstream port unit and the downstream port unit, and the downstream port unit reproduces a bus status detected by the upstream port unit and transmits the bus status to the USB device, and the upstream port unit reproduces a bus status detected by the downstream port unit and transmits the bus status to the USB host.

According to this aspect of the invention, because the packet or bus status between the USB host and the USB device is relayed, the waveform of the signal corresponding to the packet or the bus status is shaped, and thus the signal waveform is not distorted on the receiving side. Also, the USB host does not recognize the presence of a device other than the USB device when the USB host performs control, and thus the USB host only needs to perform control on the USB device as conventional USB hosts do. As a result, even when the signal waveform is disturbed on the receiving side and preferable communication is not performed, by applying the present invention, communication between the USB host and the USB device can be appropriately performed.

(2) In the above-described bus relay apparatus, it is preferable that a first communication speed mode is determined by a negotiation between the downstream port control unit and the USB device, and that a negotiation for establishing a connection in the first communication speed mode is executed between the upstream port control unit and the USB host.

According to this aspect of the invention, a negotiation is performed with the USB device so as to determine the first communication speed mode, and thereafter a negotiation is performed with the USB host. Accordingly, the negotiation with the USB host is performed with the bus relay apparatus according to the invention, and thus a system can be configured in which the bus relay apparatus according to the invention is included in the USB device.

(3) In the above-described bus relay apparatus, it is preferable that the downstream port control unit knows in advance a communication speed mode of the USB host, and that it is determined, in the negotiation between the downstream port control unit and the USB device, whether or not communication can be performed in the communication speed mode of the USB host.

According to this aspect of the invention, when the communication speed mode supported by the USB host is known in advance, the bus relay apparatus can quickly perform a speed negotiation with the USB host and the USB device.

(4) In the above-described bus relay apparatus, it is preferable that after the downstream port control unit has detected an attachment of the USB device to the downstream port unit, a first communication speed mode is determined by a negotiation between the upstream port control unit and the USB host, and a negotiation for establishing a connection in the first communication speed mode is executed between the downstream port control unit and the USB device.

According to this aspect of the invention, after an attachment of the USB device to the downstream port unit has been detected, a negotiation is performed with the USB host to determine the first communication speed mode, and thereafter a negotiation is performed with the USB device. Accordingly, the negotiation with the USB device is performed with the bus relay apparatus according to the invention, and thus a system can be configured in which the bus relay apparatus according to the invention is included in the USB device.

(5) In the above-described bus relay apparatus, it is preferable that the upstream port control unit knows in advance a communication speed mode of the USB device, and it is determined, in the negotiation between the upstream port control unit and the USB host, whether or not communication can be performed in the communication speed mode of the USB device.

According to this aspect of the invention, when the communication speed mode supported by the USB device is known in advance, the bus relay apparatus can quickly perform a speed negotiation with the USB host and the USB device, in addition to the above-described effects.

(6) In the above-described bus relay apparatus, it is preferable that the relay unit transmits a signal corresponding to the packet relayed between the upstream port unit and the downstream port unit.

According to this aspect of the invention, the distortion of the signal waveform on the receiving side can be prevented by transmitting a signal corresponding to the relayed packet, and thus communication between the USB host and the USB device can be appropriately performed.

(7) An integrated circuit apparatus according to an aspect of the invention preferably includes the above-described bus relay apparatus and the USB host that is connected to the above-described upstream port unit.

According to this aspect of the invention, the distortion of the signal waveform on the receiving side can be prevented by the above-described bus relay apparatus, whereby more appropriate communication can be performed between the USB host and the USB device, and an integrated circuit apparatus having a USB host function can be provided.

(8) An integrated circuit apparatus according to another aspect of the invention preferably includes the above-described bus relay apparatus and the USB device that is connected to the above-described downstream port unit.

According to this aspect of the invention, the distortion of the signal waveform on the receiving side can be prevented by the above-described bus relay apparatus, and an integrated circuit apparatus that has a USB device function and enables more appropriate communication between the USB host and the USB device can be provided.

(9) A cable according to an aspect of the invention preferably includes: a first USB connector; a first bus to which the first USB connector is connected at one end thereof; the bus relay apparatus according to any one of the above-described aspects whose upstream port unit is connected to the other end of the first bus; a second bus to which the downstream port unit is connected at one end thereof; and a second USB connector that is connected to the other end of the second bus.

According to this aspect of the invention, it is possible to provide a cable in which the distortion of the signal waveform on the receiving side can be prevented by the above-described bus relay apparatus, and that implements communication between the USB host and the USB device.

(10) A connector according to an aspect of the invention preferably includes: a USB connector; and the bus relay apparatus according to any one of the above-described aspects whose upstream port unit or downstream port unit is connected to the USB connector.

According to this aspect of the invention, it is possible to provide a connector in which the distortion of the signal waveform on the receiving side can be prevented by the above-described bus relay apparatus, and that implements communication between the USB host and the USB device.

(11) An electronic appliance according to an aspect of the invention preferably includes: the bus relay apparatus according to any one of the above-described aspects.

According to this aspect of the invention, it is possible to provide an electronic appliance in which the distortion of the signal waveform on the receiving side can be prevented by the above-described bus relay apparatus, and that implements communication between the USB host and the USB device.

(12) A bus relay method according to an aspect of the invention is a bus relay method performed between an upstream port unit to which a USB host is connected and a downstream port unit to which a USB device is connected, the bus relay method including: a first connection step of performing a negotiation with the USB device according to a communication speed mode with the USB host; a second connection step of performing a negotiation with the USB host after the first connection step; and a relay step of relaying a packet or a bus status between the upstream port unit and the downstream port unit after the second connection step.

According to this method, the waveform of the signal transferred between the USB host and the USB device can be shaped, and thus the distortion of the signal waveform on the receiving side can be prevented. Also, the USB host recognizes only the presence of the USB device when the USB host performs control, and thus the processing load on the USB host is not increased. As a result, more appropriate communication can be performed between the USB host and the USB device.

(13) A bus relay method according to another aspect of the invention is a bus relay method performed between an upstream port unit to which a USB host is connected and a downstream port unit to which a USB device is connected, the bus relay method including: a detection step of detecting an attachment of the USB device to the downstream port unit; a first connection step of performing a negotiation with the USB host according to a communication speed mode with the USB device after the detection step; a second connection step of performing a negotiation with the USB device after the first connection step; and a relay step of relaying a packet or a bus status between the upstream port unit and the downstream port unit after the second connection step.

According to this method, the waveform of the signal transferred between the USB host and the USB device can be shaped, and thus the distortion of the signal waveform on the receiving side can be prevented. Also, the USB host recognizes only the presence of the USB device when the USB host performs control, and thus the processing load on the USB host is not increased. As a result, more appropriate communication can be performed between the USB host and the USB device.

(14) In the above-described bus relay method, it is preferable that in the relay step, a bus status generated by one of the upstream port unit and the downstream port unit is reproduced and transmitted by the other port unit, and a signal corresponding to the packet relayed between the upstream port unit and the downstream port unit is amplified.

According to this method, the distortion of the signal waveform on the receiving side can be prevented as a result of a signal corresponding to the packet between the USB host and the USB device being relayed, and thus communication can be performed between the USB host and the USB device.

### BRIEF DESCRIPTION OF THE DRAWINGS

The invention will be described with reference to the accompanying drawings, wherein like numbers reference like elements.

FIG. 1 is a block diagram showing an example of a configuration of a communication system according to a first embodiment.

FIG. 2 is a block diagram showing an example of a configuration of a bus relay apparatus shown in FIG. 1.

FIG. 3 is a flowchart illustrating an example of control performed by the bus relay apparatus according to the first embodiment.

FIG. 4 is a diagram showing an example of an operation sequence performed by the bus relay apparatus according to the first embodiment.

FIG. 5 is a diagram showing another example of an operation sequence performed by the bus relay apparatus according to the first embodiment.

FIG. 6 is a block diagram showing an example of a configuration of an integrated circuit apparatus to which the bus relay apparatus according to the first embodiment is applied.

FIG. 7 is a flowchart illustrating an example of control performed by a bus relay apparatus according to a second embodiment.

FIG. 8 is a diagram showing an example of an operation sequence performed by the bus relay apparatus according to the second embodiment.

FIG. 9 is a diagram showing another example of an operation sequence performed by the bus relay apparatus according to the second embodiment.

FIG. 10 is a block diagram showing an example of a configuration of an integrated circuit apparatus to which the bus relay apparatus according to the second embodiment is applied.

FIG. 11 is a diagram showing an example of a configuration of a communication system according to a first variation.

FIG. 12 is a diagram showing an example of a configuration of a communication system according to a second variation.

FIG. 13 is a block diagram showing an example of a configuration of a USB cable to which the bus relay apparatus according to any one of the first embodiment, the second embodiment and the variations thereof is applied.

FIG. 14 is a block diagram showing an example of a configuration of a connector to which the bus relay apparatus according to any one of the first embodiment, the second embodiment and the variations thereof is applied.

FIGS. 15A and 15B are block diagrams showing examples of configurations of electronic appliances to which the bus relay apparatus according to any one of the first embodiment, the second embodiment and the variations thereof is applied.

FIG. 16 is a diagram showing an example of a configuration of a commonly used communication system including a USB host and a USB device.

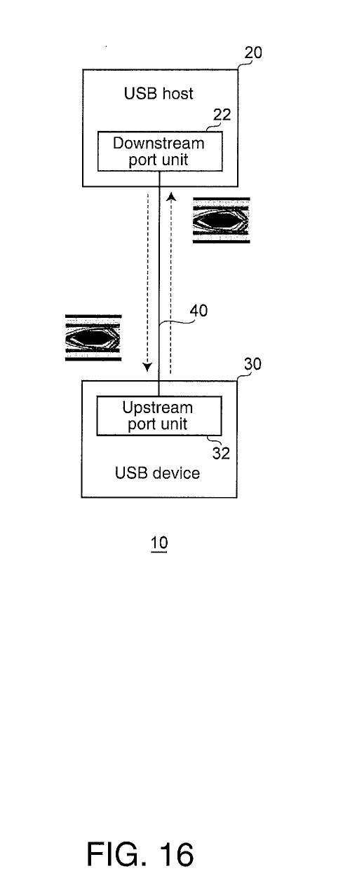

### DESCRIPTION OF EXEMPLARY EMBODIMENTS

Hereinafter, embodiments of the invention will be described in detail with reference to the drawings. It is to be understood that the embodiments described below are not intended to unduly limit the scope of the invention recited in the appended claims. It is also to be understood that all of the constituent elements described below are not necessarily required to solve the problems of the invention.

Hereinafter, for the sake of simplifying the description, it is assumed that the USB 2.0 standard is used as the USB standard, and USB hosts and USB devices that support the USB 2.0 standard have a communication speed mode of either a high speed (HS) mode or a full speed (FS) mode.

Bus Relay Apparatus

### 1. First Embodiment

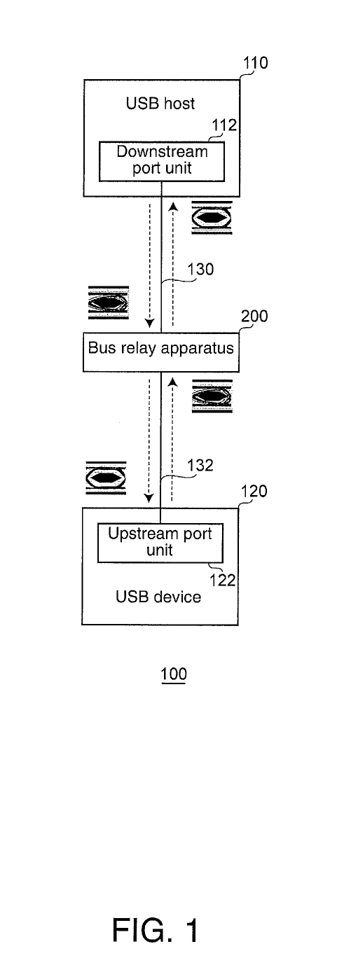

FIG. 1 shows an example of a configuration of a communication system according to a first embodiment of the invention.

A communication system 100 according to the first embodiment includes a USB host 110, a USB device 120 and a bus relay apparatus 200. The bus relay apparatus 200 is provided between the USB host 110 and the USB device 120. The USB host 110 and the bus relay apparatus 200 are connected via a USB bus (hereinafter, referred to as a “bus”) 130 specified by the USB standard, and the bus relay apparatus 200 and the USB device 120 are connected by a bus 132 specified by the USB standard.

The USB host 110 has a downstream port unit 112, and the USB device 120 has an upstream port unit 122. Each of the buses 130 and 132 includes two power supply lines VBUS and GND, and two signal lines DP (D+) and DM (D−) that are differential buses.

One end of the bus 130 is connected to the downstream port unit 112, and the other end is connected to the bus relay apparatus 200. The USB host 110 and the bus relay apparatus 200 perform communication specified by the USB standard via bus 130. One end of the bus 132 is connected to the bus relay apparatus 200, and the other end is connected to the upstream port unit 122. The USB device 120 and the bus relay apparatus 200 perform communication specified by the USB standard via the bus 132.

The bus relay apparatus 200 performs a speed negotiation with each of the USB host 110 and the USB device 120 such that the communication speed mode with the USB host 110 and the communication speed mode with the USB device 120 are the same, and functions as a repeater that relays a packet or a bus status between the USB host 110 and the USB device 120.

To be specific, the bus relay apparatus 200 includes an upstream port unit to which the USB host 110 is connected via the bus 130 and a downstream port unit to which the USB device 120 is connected via the bus 132. The bus relay apparatus 200 reproduces, on the downstream port unit side, a bus status (reset, suspend, resume or disconnection) generated on the upstream port unit side and transmits the bus status. Also, the bus relay apparatus 200 relays a packet from the USB host 110 received on the upstream port unit side to the downstream port unit side and transfers the packet to the USB device 120.

Likewise, the bus relay apparatus 200 reproduces, on the upstream port unit side, a bus status (resume or disconnection) generated on the downstream port unit side and transmits the bus status. Also, the bus relay apparatus 200 relays a packet from the USB device 120 received on the downstream port unit side to the upstream port unit side and transfers the packet to the USB host 110.

According to the first embodiment, the waveform of a signal corresponding to a packet or a bus status can be shaped between the USB host 110 and the USB device 120 by the bus relay apparatus 200, and therefore the waveform of the signal is not distorted on the receiving side (FIG. 1). In addition, the USB host 110 recognizes only the presence of the USB device 120, and not a USB hub, when it performs control on the USB device 120, and thus the USB host 110 only needs to perform control on the USB device 120 as conventional USB hosts do. Also, the bus relay apparatus 200 performs a speed negotiation with each of the USB host 110 and the USB device 120 such that the communication speed mode with the USB host 110 and the communication speed mode with the USB device 120 are the same, and therefore the bus relay apparatus 200 can eliminate the need of a transaction translator function provided in a USB hub. As a result, even when the signal waveform is disturbed on the receiving side, the USB host and the USB device can communicate with each other with a simpler configuration without providing a USB hub.

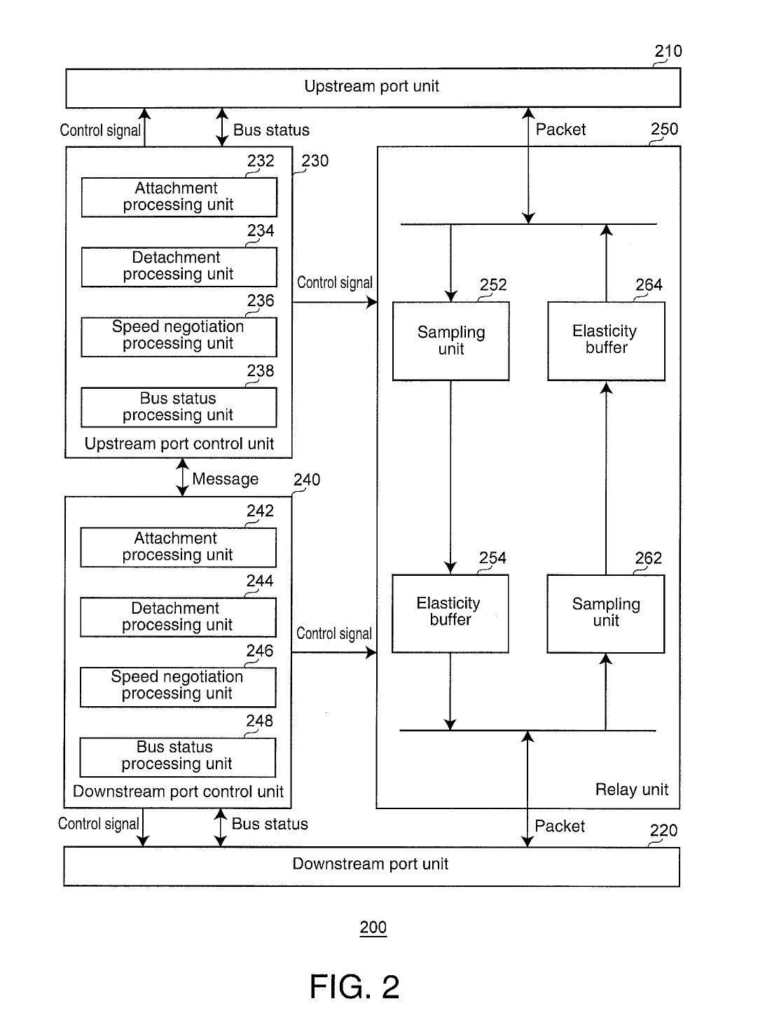

FIG. 2 is a block diagram showing an example of a configuration of the bus relay apparatus 200 shown in FIG. 1.

The bus relay apparatus 200 includes an upstream port unit 210, a downstream port unit 220, an upstream port control unit 230, a downstream port control unit 240, and a relay unit 250.

The upstream port control unit 230 includes an attachment processing unit 232, a detachment processing unit 234, a speed negotiation processing unit 236, and a bus status processing unit 238.

The downstream port control unit 240 includes an attachment processing unit 242, a detachment processing unit 244, a speed negotiation processing unit 246, and a bus status processing unit 248.

The relay unit 250 includes sampling units 252 and 262, and elasticity buffers 254 and 264.

The USB host 110 is connected to the upstream port unit 210 via the bus 130. The USB device 120 is connected to the downstream port unit 220 via the bus 132.

Each of the upstream port unit 210 and the downstream port unit 220 includes a driver, a receiver, an NRZI decoder/encoder, a synchronous detection circuit, and a squelch detection circuit. Such a driver and the like are specified by the USB 2.0 standard, and thus they are not illustrated in the diagram.

The driver includes an HS driver that is used when an HS mode has been selected, and an FS driver that is used when an FS mode or an LS mode has been selected.

The receiver includes an HS receiver that is used when an HS mode has been selected, an FS receiver that is used when an FS mode or an LS mode has been selected, and various other receivers specified by the USB 2.0 standard.

The NRZI decoder/encoder converts an NRZ coded signal within the bus relay apparatus 200 into an NRZI coded signal, or converts an NRZI coded signal transferred by the bus into an NRZ coded signal.

The synchronous detection circuit detects a change in a received signal, and detects the synchronization of the received signal.

The squelch detection circuit detects whether the state is a state in which valid data (packets) is transferred or a state in which valid data (packets) is not transferred.

The upstream port control unit 230 controls the upstream port unit 210, and also controls relay processing of the relay unit 250.

The attachment processing unit 232 performs an attachment of the USB host 110 to the upstream port unit 210, or performs control to monitor the attachment, for example. The attachment of the USB host 110 is implemented by the attachment processing unit 232 performing, as attachment processing, a pull-up (FS termination) on the signal line DP, with the USB host 110 supplying power to the power supply line VBUS.

The detachment processing unit 234 performs a detachment of the USB host 110 connected to the upstream port unit 210, or performs control to detect the detachment, for example. The detachment of the USB host 110 is implemented by turning off an HS termination (by the FS driver outputting SE0 (DP=DM=L) to turn on the HS driver and the HS receiver) when the mode is in an HS mode, and turning off an FS termination when the mode is in an FS mode.

The speed negotiation processing unit 236 controls a speed negotiation with the USB host 110 by controlling the upstream port unit 210.

The bus status processing unit 238 detects a bus status generated in the upstream port unit 210, and transmits the bus status designated as a result of controlling the upstream port unit 210.

The downstream port control unit 240 controls the downstream port unit 220, and also controls relay processing of the relay unit 250.

To be specific, the attachment processing unit 242 performs an attachment of the USB device 120 to the downstream port unit 220, or performs control to monitor the attachment, for example. The attachment of the USB device 120 is implemented by, for example, the USB device 120 performing an FS termination, with the attachment processing unit 242 supplying power to the power supply line VBUS.

The detachment processing unit 244 performs a detachment of the USB device 120 connected to the downstream port unit 220, or performs control to detect the detachment, for example. The detachment of the USB device 120 is implemented by the detachment processing unit 244 stopping power supply to the power supply line VBUS.

The speed negotiation processing unit 246 controls a speed negotiation with the USB device 120 by controlling the downstream port unit 220.

The bus status processing unit 248 detects a bus status generated by the downstream port unit 220, and transmits the bus status designated as a result of controlling the downstream port unit 220.

The upstream port control unit 230 and the downstream port control unit 240 perform transmission and reception of messages to cooperate with each other.

The upstream port control unit 230 relays a bus status generated by the downstream port unit 220 to the upstream port unit 220 by receiving a message from the downstream port control unit 240.

Conversely, the downstream port control unit 240 relays a bus status generated by the upstream port unit 210 to the downstream port unit 220 by receiving a message from the upstream port control unit 230.

The relay unit 250 samples a signal corresponding to a packet received by the upstream port unit 210, buffers the sampled signal, and then outputs the signal to the downstream port unit 220.

To be specific, the sampling unit 252 samples a signal corresponding to a packet received by the upstream port unit 210. Then, the elasticity buffer 254 outputs the sampled signal while absorbing the frequency difference between the input side and the output side.

Also, the relay unit 250 samples a signal corresponding to a packet received by the downstream port unit 220, buffers the sampled signal, and then outputs the signal to the upstream port unit 210.

To be specific, the sampling unit 262 samples a signal corresponding to a packet received by the downstream port unit 220. Then, the elasticity buffer 264 outputs the sampled signal while absorbing the frequency difference between the input side and the output side.

Next, an example of operations of the bus relay apparatus 200 according to the first embodiment will be described.

In the following, it is assumed that the bus relay apparatus 200 already knows that the USB host 110 is capable of communication (connection) in the HS mode according to the USB 2.0 standard. For example, the bus relay apparatus 200 determines whether or not the USB host 110 is capable of communication in the HS mode according to the USB 2.0 standard, based on the settings of a built-in control register or an external terminal (not shown).

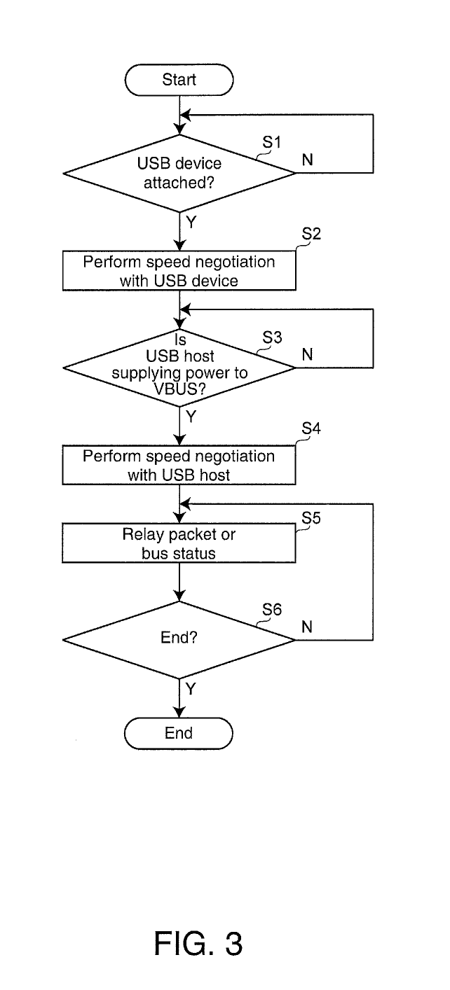

FIG. 3 shows a flowchart illustrating an example of control performed by the bus relay apparatus 200 according to the first embodiment. The components of the bus relay apparatus 200 shown in FIG. 2 perform control in accordance with the flowchart shown in FIG. 3.

First, the downstream port control unit 240 monitors an attachment of the USB device 120 to the downstream port unit 220, with the use of the attachment processing unit 242 (step S1: N).

If an attachment of the USB device 120 is detected (step S1: Y), the downstream port control unit 240 performs a speed negotiation for connecting to the USB device 120 in the HS mode (step S2). It is assumed here that it is already known that the USB host 110 is capable of communication in the HS mode that is a first communication speed mode. Accordingly, in step S2, the downstream port control unit 240 performs control on a speed negotiation for connecting to the USB device 120 in the HS mode, with the use of the speed negotiation processing unit 246. In other words, in step S2, the speed negotiation processing unit 246 controls the speed negotiation with the USB device 120 according to the communication speed mode of communication with the USB host 110. Step S2 corresponds to a first connection step according to the first embodiment.

Note that if the USB host 110 is capable of communication in the FS mode, the speed negotiation processing unit 246 controls a speed negotiation for connecting to the USB device 120 in the FS mode.

Subsequently, the upstream port control unit 230 monitors power supply to the power supply line VBUS by the USB host 110 in the upstream port unit 210, with the use of the attachment processing unit 232 (step S3: N).

If power supply to the power supply line VBUS is detected (step S3: Y), the upstream port control unit 230 performs control on a speed negotiation for connecting to the USB host 110 in the HS mode (step S4). To be specific, the upstream port control unit 230 performs control on a speed negotiation for connecting to the USB host 110 in the communication speed mode determined in step S2, with the use of the speed negotiation processing unit 236. Step S4 corresponds to a second connection step according to the first embodiment.

As a result of step S4, the USB device 120 and the USB host 110 are connected in the HS mode or the FS mode. Then, the bus relay apparatus 200 relays a packet or a bus status (step S5). Specifically, in step S5, the relay unit 250 relays a packet transferred between the upstream port unit 210 and the downstream port unit 220. Also, the bus status processing unit 238 detects a bus status generated in the upstream port unit 210, and the bus status processing unit 248 reproduces and transmits the detected bus status by controlling the downstream port unit 220. Alternatively, the bus status processing unit 248 detects a bus status generated by the downstream port unit 220, and the bus status processing unit 238 reproduces and transmits the detected bus status by controlling the upstream port unit 210. Step S5 corresponds to a relay step according to the first embodiment.

After that, if the series of processing does not end (step S6: N), the procedure returns to step S5, where the bus relay apparatus 200 continues to relay the packet or the bus status. If, on the other hand, the processing ends in step S6 (step S6: Y), the bus relay apparatus 200 ends the series of processing (end).

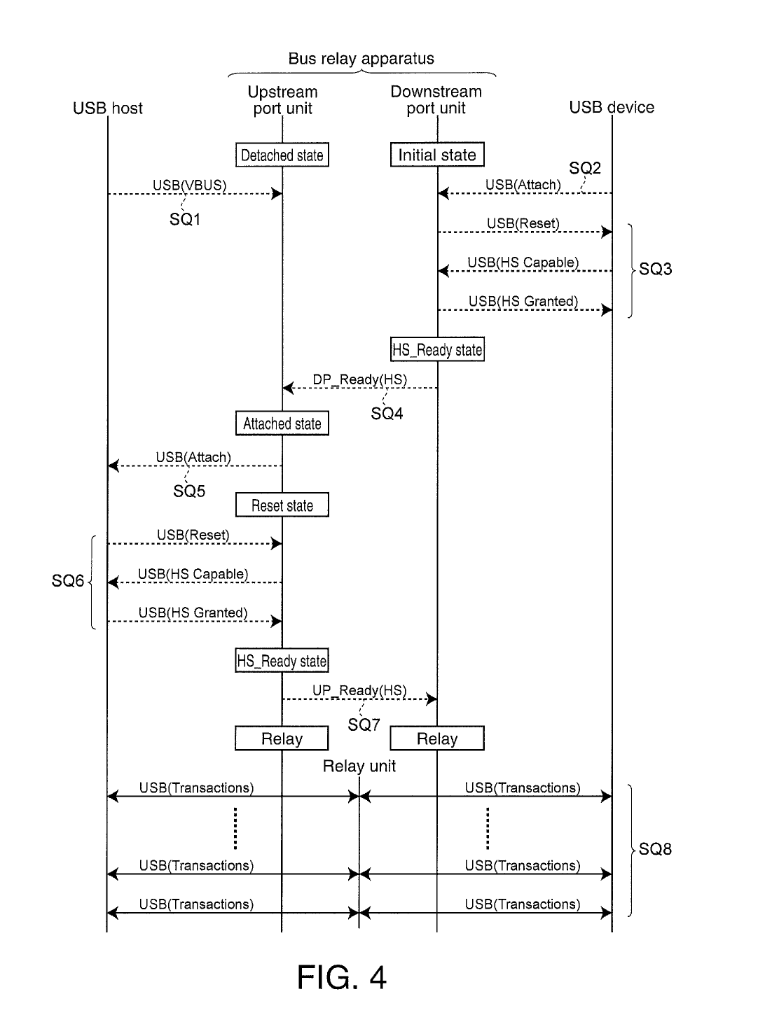

FIG. 4 shows an example of an operation sequence of the bus relay apparatus 200 according to the first embodiment. FIG. 4 shows an example of a sequence performed when the USB host 110 and the USB device 120 are capable of communication in the HS mode.

First, it is assumed that the USB host 110 is connected to the upstream port unit 210, and power is supplied to the power supply line VBUS (SQ1). At this time, the attachment processing unit 232 does not perform attachment processing, and thus the upstream port unit 210 remains in a detached state.

After that, the attachment processing unit 242 detects an attachment of the USB device 120 to the downstream port unit 220 that is in an initial state (SQ2). The attachment processing unit 242 detects the attachment of the USB device 120 by detecting a pull-up of the signal line DP, with power being supplied to the power supply line VBUS. The power supply to the power supply line VBUS may be performed by the bus relay apparatus 200 or an apparatus other than the bus relay apparatus 200.

Subsequently, the speed negotiation processing unit 246 controls a speed negotiation with the USB device 120 (SQ3).

To be specific, the speed negotiation processing unit 246 causes the bus status processing unit 248 to control the downstream port unit 220 so as to issue a bus reset. The bus reset is issued by setting the signal line DP to L level and the signal line to L level.

The USB device 120 that has detected the bus reset notifies the bus relay apparatus 200 that communication in the HS mode is possible (HS Capable). This notification is implemented with a chirp that drives data K (DP=L, DM=L), with the FS termination being turned on.

In response to this notification, the speed negotiation processing unit 246 controls the downstream port unit 220 to permit connection in the HS mode (HS Granted), and thereby the HS mode is selected. The permission of connection in the HS mode is performed by alternately driving data K and data J (DP=H, DP=L) with the use of the signal lines DP and DM (by returning a chirp). Upon selection of the HS mode, the FS termination is turned off, and the HS termination is turned on.

As a result, the downstream port unit 220 enters an HS_Ready state, and the downstream port control unit 240 sends a message UP_Ready (HS) to the upstream port control unit 230 (SQ4).

The upstream port control unit 230 that has received the message DP_Ready (HS) controls the upstream port unit 210 that has entered an attached state, and performs attachment processing, with the use of the attachment processing unit 232 (SQ5).

After that, the upstream port unit 210 enters a reset state, and the upstream port control unit 230 performs control on a speed negotiation with the USB host 110, with the use of the speed negotiation processing unit 236 (SQ6).

To be specific, upon issuance of a bus reset by the USB host 110, the speed negotiation processing unit 236 controls the upstream port unit 210 so as to notify the USB host 110 that communication in the HS mode is possible (HS Capable).

In response to this notification, the USB host 110 permits connection in the HS mode (HS Granted), and the HS mode is selected.

As a result, the upstream port unit 210 enters an HS_Ready state, and the upstream port control unit 230 sends a message UP_Ready (HS) to the downstream port control unit 240 (SQ7).

After that, each of the upstream port unit 210 and the downstream port unit 220 enters a relay state, and the bus relay apparatus 200 becomes capable of communication in the HS mode with each of the USB host 110 and the USB device 120. Then, the bus relay apparatus 200 relays a packet or a bus status between the USB host 110 and the USB device 120 (SQ8).

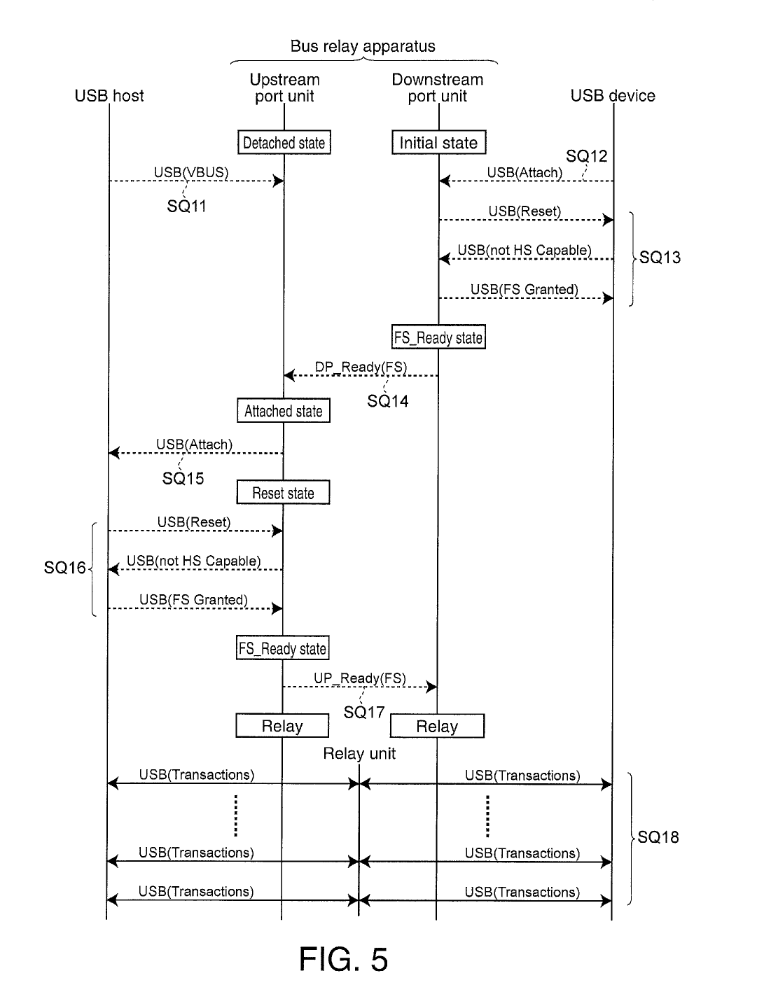

FIG. 5 shows another example of an operation sequence of the bus relay apparatus 200 according to the first embodiment. FIG. 5 shows an example of a sequence performed when the USB host 110 is capable communication in the HS mode, and the USB device 120 is capable of communication in the FS mode.

First, it is assumed that the USB host 110 is connected to the upstream port unit 210, and power is supplied to the power supply line VBUS (SQ11). At this time, the attachment processing unit 232 does not perform attachment processing, and thus the upstream port unit 210 remains in a detached state.

After that, the downstream port control unit 240 detects an attachment of the USB device 120 to the downstream port unit 220 that is in an initial state, with the use of the attachment processing unit 242 (SQ12).

Subsequently, the speed negotiation processing unit 246 performs control on a speed negotiation with the USB device 120 (SQ13).

To be specific, the speed negotiation processing unit 246 controls the downstream port unit 220 so as to issue a bus reset.

The USB device 120 that has detected the bus reset notifies the bus relay apparatus 200 that communication in the FS mode is possible (not HS Capable). This notification is implemented by not performing a chirp for a predetermined period of time.

In response to this notification, the speed negotiation processing unit 246 controls the downstream port unit 220 to permit connection in the FS mode (FS Granted), and the FS mode is selected. The permission of connection in the FS mode is implemented by not returning a chirp for a predetermined period of time. Upon selection of the FS mode, the FS termination is turned on, and the HS termination is turned off.

As a result, the downstream port unit 220 enters an FS_Ready state, and the downstream port control unit 240 sends a message DP_Ready (FS) to the upstream port control unit 230 (SQ14).

The upstream port control unit 230 that has received the message DP_Ready (FS) controls the upstream port unit 210 that has entered an attached state, and the attachment processing unit 232 performs attachment processing (SQ15).

After that, the upstream port control unit 230 enters a reset state, and performs control on a speed negotiation with the USB host 110 (SQ16).

To be specific, upon issuance of a bus reset by the USB host 110, the speed negotiation processing unit 236 notifies the USB host 110 that communication in the FS mode is possible (not HS Capable).

In response to this notification, the USB host 110 permits connection in the FS mode (FS Granted), and the FS mode is selected.

As a result, the upstream port unit 210 enters an FS_Ready state, and the upstream port control unit 230 sends a message UP_Ready (FS) to the downstream port control unit 240 (SQ17).

After that, each of the upstream port unit 210 and the downstream port unit 220 enters a relay state, and the bus relay apparatus 200 becomes capable of communication in the FS mode with each of the USB host 110 and the USB device 120. Then, the bus relay apparatus 200 relays a packet or a bus status between the USB host 110 and the USB device 120 (SQ18).

FIGS. 4 and 5 have been described on the assumption that the bus relay apparatus 200 knows in advance that the USB host 110 is capable of communication in the HS mode according to the USB 2.0 standard, but the first embodiment is not limited thereto. The first embodiment is equally applied to the case where the bus relay apparatus 200 knows in advance that the USB host 110 is capable of communication in the FS mode or the LS mode according to the USB standard.

As described above, according to the first embodiment, with the bus relay apparatus 200 provided between the USB host 110 and the USB device 120, the waveform of a signal transferred between the USB host 110 and the USB device 120 can be shaped. At this time, the bus relay apparatus 200 reproduces a packet or a bus status generated by one of the upstream port unit side and the downstream port unit side, on the other side. With this configuration, the USB host 110 recognizes only the presence of the USB device 120, and not a USB hub, when it performs control on the USB device 120, and thus the USB host 110 only needs to perform control on the USB device 120 as conventional USB hosts do. As a result, even when the signal waveform is disturbed, the USB host and the USB device can communicate with each other with a simpler configuration without providing a USB hub.

Also, the bus relay apparatus 200 is configured such that the communication speed on the upstream port unit side and the communication speed on the downstream port unit side match with each other, and it is therefore possible to eliminate the need of a transaction translator function provided in a USB hub. This enables communication between the USB host and the USB device with an even simpler configuration.

Furthermore, the bus relay apparatus 200 performs a speed negotiation with the USB host 110 after it has performed a speed negotiation with the USB device 120. It is thereby possible to reliably relay a packet or a bus status from the USB host 110 to the USB device 120.

In the first embodiment, the bus relay apparatus 200 knows in advance that the USB host 110 is capable of communication in the HS mode according to the USB 2.0 standard, and thus an integrated circuit apparatus as described below may be configured.

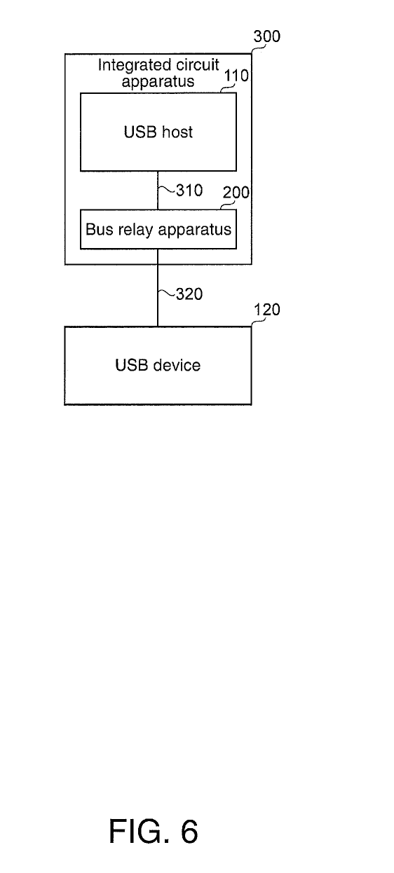

FIG. 6 is a block diagram showing an example of a configuration of an integrated circuit apparatus to which the bus relay apparatus 200 according to the first embodiment is applied. In FIG. 6, the same reference numerals are given to components that are the same as those shown in FIG. 1, and a description thereof is omitted as appropriate.

An integrated circuit apparatus 300 includes a USB host 110 and a bus relay apparatus 200, and the USB host 110 and the bus relay apparatus 200 are connected via a bus (internal bus) 310. A USB device 120 is connected to the integrated circuit apparatus 300 via a bus 320. The buses 310 and 320 are those specified by the USB standard.

In the integrated circuit apparatus 300 described above, the USB host 110 having a known ability and the bus relay apparatus 200 are integrated in the same apparatus. Accordingly, the need to provide a USB hub can be eliminated, and communication can be performed between the USB host and the USB device at a lower cost and with a simpler configuration.

### 2. Second Embodiment

The first embodiment has been described taking an example in which the bus relay apparatus 200 knows in advance a communication speed supported by the USB host 110. The second embodiment will be described taking an example in which the bus relay apparatus 200 knows in advance a communication speed supported by the USB device 120.

A bus relay apparatus according to the second embodiment has the same configuration as the bus relay apparatus 200 according to the first embodiment, and thus a description and illustration thereof are omitted here. For the sake of simplifying the description, an example of operations of the bus relay apparatus according to the second embodiment will be described below by using the reference numerals of the components of the bus relay apparatus 200 shown in FIG. 2.

In the following, it is assumed that the bus relay apparatus 200 already knows that the USB device 120 is capable of communication in the HS mode according to the USB 2.0 standard. For example, the bus relay apparatus 200 determines whether or not the USB device 120 is capable of communication in the HS mode according to the USB 2.0 standard, based on the settings of a built-in control register or an external terminal (not shown).

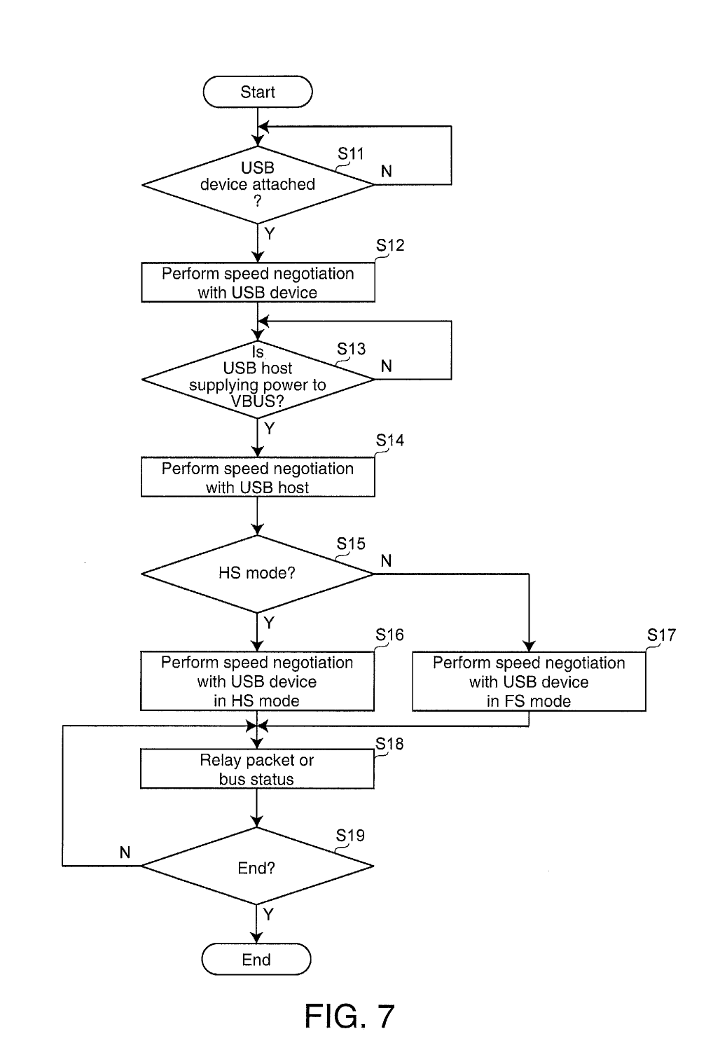

FIG. 7 shows a flowchart illustrating an example of control performed by the bus relay apparatus 200 according to the second embodiment. The components of the bus relay apparatus 200 shown in FIG. 2 perform control in accordance with the flowchart shown in FIG. 7.

First, the downstream port control unit 240 monitors an attachment of the USB device 120 to the downstream port unit 220, with the use of the attachment processing unit 242 (step S11: N). Step S11 corresponds to a detection step according to the second embodiment.

If an attachment of the USB device 120 is detected (step S11: Y), the downstream port control unit 240 performs a speed negotiation for connecting to the USB device 120 in the HS mode, with the use of the speed negotiation processing unit 246 (step S12).

In the case where the USB device 120 is capable of communication in the FS mode, the speed negotiation processing unit 246 performs a speed negotiation for connecting to the USB device 120 in the FS mode.

Subsequently, the upstream port control unit 230 monitors power supply to the power supply line VBUS by the USB host 110 in the upstream port unit 210, with the use of the attachment processing unit 232 (step S13: N).

If power supply to the power supply line VBUS is detected (step S13: Y), the upstream port control unit 230 performs control on a speed negotiation for connecting to the USB host 110 in the HS mode, with the use of the speed negotiation processing unit 236 (step S14). It is assumed here that it is known that the USB device 120 is capable of communication in the HS mode that is a first communication speed mode. Accordingly, in step S14, the upstream port control unit 230 performs control on a speed negotiation for connecting to the USB host 110 in the HS mode, with the use of the speed negotiation processing unit 236. In other words, in step S14, the speed negotiation processing unit 236 controls the speed negotiation with the USB host 110 according to the communication speed mode of communication with the USB device 120. Step S14 corresponds to a first connection step according to the second embodiment.

As a result of step S14, if it is possible to perform communication in the HS mode (step S15: Y), the downstream port control unit 240 performs control on a speed negotiation for connecting to the USB device 120 in the HS mode, with the use of the speed negotiation processing unit 246 (step S16).

If, on the other hand, it is not possible to perform communication in the HS mode (step S15: N), the downstream port control unit 240 performs control on a speed negotiation for connecting to the USB device 120 in the FS mode, with the use of the speed negotiation processing unit 246, (step S17).

Steps S16 and S17 correspond to a second connection step according to the second embodiment. The control of speed negotiation performed in step S16 may be omitted by maintaining the controlled state in step S12.

As a result of step S16 or S17, the USB device 120 and the USB host 110 are connected in the HS mode or the FS mode. Then, the bus relay apparatus 200 relays a packet or a bus status (step S18). Step S18 corresponds to a relay step according to the second embodiment.

Subsequently, if the series of processing does not end (step S19: N), the procedure returns to step S18, where the bus relay apparatus 200 continues to relay the packet or the bus status. If, on the other hand, the processing ends in step S19 (step S19: Y), the bus relay apparatus 200 ends the series of processing (end).

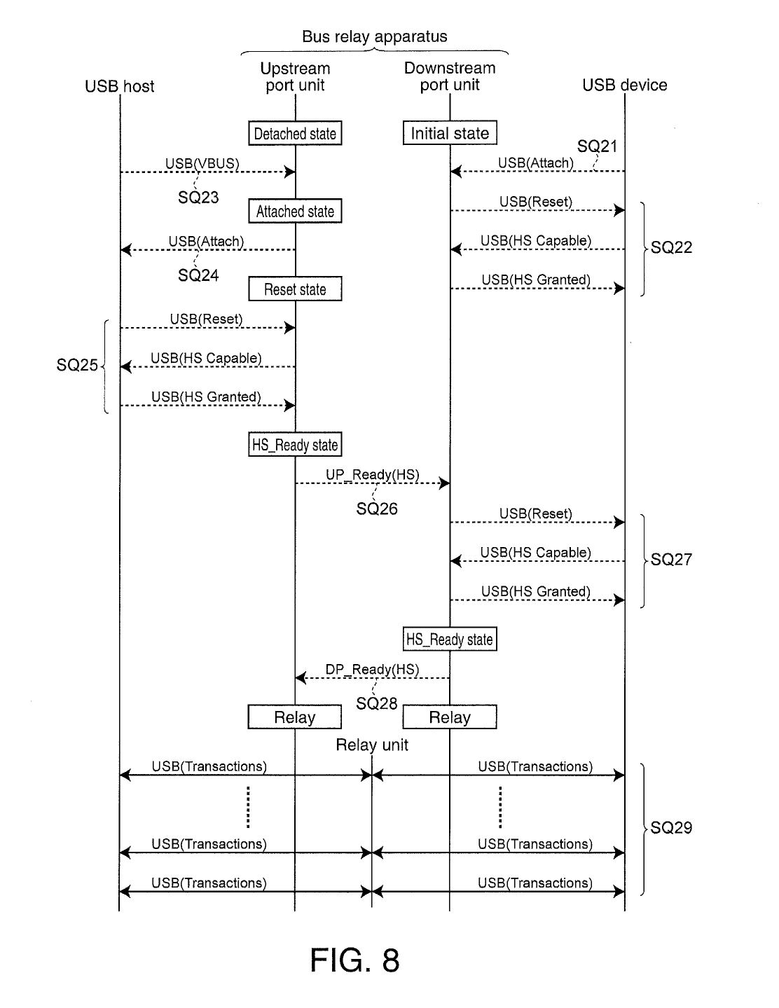

FIG. 8 shows an example of an operation sequence of the bus relay apparatus 200 according to the second embodiment. FIG. 8 shows an example of a sequence performed when the USB host 110 and the USB device 120 are capable of communication in the HS mode.

First, the downstream port control unit 240 detects an attachment of the USB device 120 to the downstream port unit 220 that is in an initial state, with the use of the attachment processing unit 242 (SQ21).

Subsequently, the speed negotiation processing unit 246 performs control on a speed negotiation with the USB device 120 (SQ22).

To be specific, the speed negotiation processing unit 246 causes the bus status processing unit 248 to control the downstream port unit 220 so as to issue a bus reset.

The USB device 120 that has detected the bus reset notifies the bus relay apparatus 200 that communication in the HS mode is possible (HS Capable).

In response to this notification, the speed negotiation processing unit 246 controls the downstream port unit 220 to permit connection in the HS mode (HS Granted), and the HS mode is selected.

Meanwhile, when the USB host 110 is connected to the upstream port unit 210 that is in a detached state, and power is supplied to the power supply line VBUS, the upstream port unit 210 enters an attached state (SQ23).

Next, the upstream port control unit 230 turns on an FS termination and performs attachment processing, with the use of the attachment processing unit 232 (SQ24), and the upstream port unit 210 enters a reset state.

After that, the upstream port control unit 230 performs control on a speed negotiation with the USB host 110, with the use of the speed negotiation processing unit 236 (SQ25).

To be specific, upon issuance of a bus reset by the USB host 110, the speed negotiation processing unit 236 controls the upstream port unit 210 so as to notify the USB host 110 that communication in the HS mode is possible (HS Capable).

In response to this notification, the USB host 110 permits connection in the HS mode (HS Granted), and the HS mode is selected.

As a result, the upstream port unit 210 enters an HS_Ready state, and the upstream port control unit 230 sends a message UP_Ready (HS) to the downstream port control unit 240 (SQ26).

Then, the speed negotiation processing unit 246 performs control on a speed negotiation with the USB device 120 (SQ27).

To be specific, the speed negotiation processing unit 246 causes the bus status processing unit 248 to control the downstream port unit 220 so as to issue a bus reset.

The USB device 120 that has detected the bus reset notifies the bus relay apparatus 200 that communication in the HS mode is possible (HS Capable).

In response to this notification, the speed negotiation processing unit 246 controls the downstream port unit 220 so as to permit connection in the HS mode (HS Granted), and the HS mode is selected.

The control on speed negotiation by the speed negotiation processing unit 246 (SQ27) corresponds to step S16 shown in FIG. 7, and this control may be omitted.

After that, the downstream port unit 220 enters an HS_Ready, and the downstream port control unit 240 sends a message DP_Ready (HS) to the upstream port control unit 230 (SQ28).

Upon reception of the message DP_Ready (HS) by the upstream port control unit 230, each of the upstream port unit 210 and the downstream port unit 220 enters a relay state. In other words, the bus relay apparatus 200 becomes capable of communication in the HS mode with each of the USB host 110 and the USB device 120. Then, the bus relay apparatus 200 relays a packet or a bus status between the USB host 110 and the USB device 120 (SQ29).

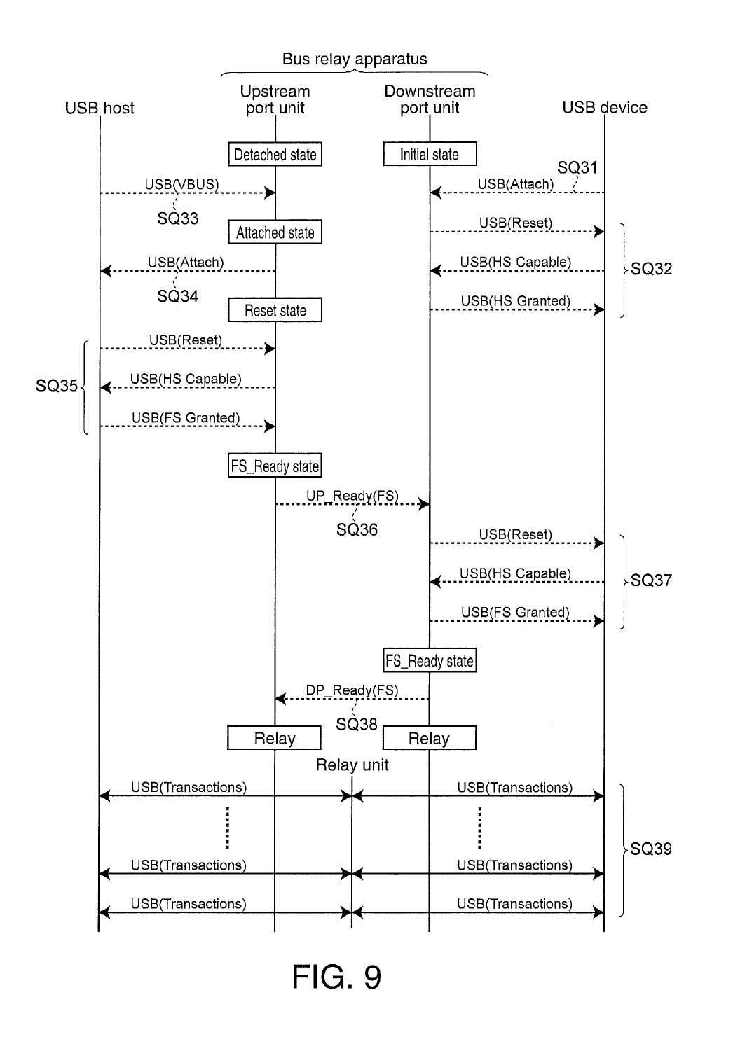

FIG. 9 shows another example of an operation sequence of the bus relay apparatus 200 according to the second embodiment. FIG. 9 shows an example of a sequence performed when the USB device 120 is capable of communication in the HS mode, and the USB host 110 is capable of communication in the FS mode.

First, the downstream port control unit 240 detects an attachment of the USB device 120 to the downstream port unit 220 that is in an initial state, with the use of the attachment processing unit 242 (SQ31).

Subsequently, the speed negotiation processing unit 246 performs control on a speed negotiation with the USB device 120 (SQ32).

To be specific, the speed negotiation processing unit 246 causes the bus status processing unit 248 to control the downstream port unit 220 so as to issue a bus reset.

The USB device 120 that has detected the bus reset notifies the bus relay apparatus 200 that communication in the HS mode is possible (HS Capable).

In response to this notification, the speed negotiation processing unit 246 controls the downstream port unit 220 so as to permit connection in the HS mode (HS Granted), and the HS mode is selected.

Meanwhile, when the USB host 110 is connected to the upstream port unit 210 that is in a detached state, and power is supplied to the power supply line VBUS, the upstream port unit 210 enters an attached state (SQ33).

Next, the upstream port control unit 230 turns on the FS termination so as to perform attachment processing, with the use of the attachment processing unit 232 (SQ34), and the upstream port unit 210 enters a reset state.

After that, the upstream port control unit 230 performs control on a speed negotiation with the USB host 110, with the use of the speed negotiation processing unit 236 (SQ35).

To be specific, upon issuance of a bus reset by the USB host 110, the speed negotiation processing unit 236 controls the upstream port unit 210 so as to notify the USB host 110 that communication in the HS mode is possible (HS Capable).

In response to this notification, the USB host 110 notifies the bus relay apparatus 200 that connection in the FS mode is performed (FS Granted), and the FS mode is selected. This notification of connection in the FS mode is implemented by not returning a chirp in response to the chirp from the upstream port unit 210 for a predetermined period of time.

As a result, the upstream port unit 210 enters an FS_Ready, and the upstream port control unit 230 sends a message UP_Ready (FS) to the downstream port control unit 240 (SQ36).

The downstream port control unit 240 that has received the message UP_Ready (FS) performs control on a speed negotiation for connecting to the USB device 120 in the FS mode, with the use of the speed negotiation processing unit 246 (SQ37).

To be specific, the downstream port control unit 240 causes the bus status processing unit 248 to control the downstream port unit 220 so as to issue a bus reset. Then, the USB device 120 notifies the bus relay apparatus 200 that communication in the HS mode is possible (HS Capable).

In response to this notification, the bus relay apparatus 200 notifies the USB device 120 that connection in the FS mode is performed, with the use of the bus status processing unit 248 (FS Granted), and the FS mode is selected.

As a result, the downstream port unit 220 enters an FS_Ready state, and the downstream port control unit 240 sends a message DP_Ready (FS) to the upstream port control unit 230 (SQ38).

Upon reception of the message DP_Ready (FS) by the upstream port control unit 230, each of the upstream port unit 210 and the downstream port unit 220 enters a relay state. In other words, the bus relay apparatus 200 becomes capable of communication in the FS mode with each of the USB host 110 and the USB device 120. Then, the bus relay apparatus 200 relays a packet or a bus status between the USB host 110 and the USB device 120 (SQ39).

FIGS. 8 and 9 have been described on the assumption that the bus relay apparatus 200 knows in advance that the USB device 120 is capable of communication in the HS mode according to the USB 2.0 standard, but the second embodiment is not limited thereto. The second embodiment is equally applied to the case where the bus relay apparatus 200 knows in advance that the USB device 120 is capable of communication in the FS mode or LS mode according to the USB standard.

As described above, according to the second embodiment, the same effects as those of the first embodiment can be obtained.

In the second embodiment, the bus relay apparatus 200 knows in advance that the USB device 120 is capable of communication in the HS mode according to the USB 2.0 standard, and thus an integrated circuit apparatus as described below may be configured.

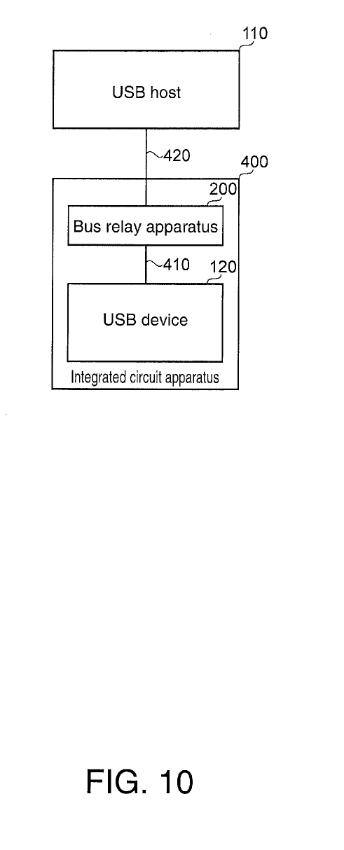

FIG. 10 is a block diagram showing an example of a configuration of an integrated circuit apparatus to which the bus relay apparatus 200 according to the second embodiment is applied. In FIG. 10, the same reference numerals are given to components that are the same as those shown in FIG. 1, and a description thereof is omitted as appropriate.

An integrated circuit apparatus 400 includes a USB device 120 and a bus relay apparatus 200, and the USB device 120 and the bus relay apparatus 200 are connected via a bus (internal bus) 410. A USB host 110 is connected to the integrated circuit apparatus 400 via a bus 420. The buses 410 and 420 are those specified by the USB standard.

In the integrated circuit apparatus 400 described above, the USB device 120 having a known ability and the bus relay apparatus 200 are integrated in the same apparatus. Accordingly, the need to provide a USB hub can be eliminated, and communication can be performed between the USB host and the USB device at a lower cost and with a simpler configuration.

### 3. Variations

### 3.1 First Variation

In the first embodiment and the second embodiment, an example was described in which one bus relay apparatus 200 is provided between the USB host 110 and the USB device 120, but the embodiments of the invention are not limited thereto.

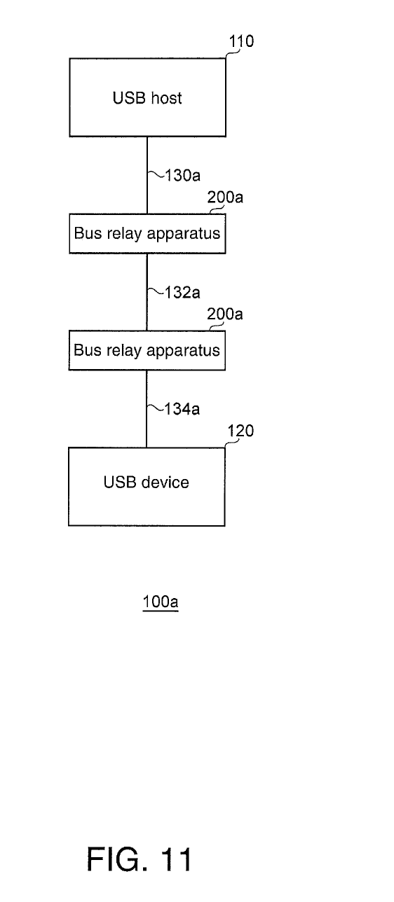

FIG. 11 shows an example of a configuration of a communication system according to a first variation of one of the embodiments described above. In FIG. 11, the same reference numerals are given to components that are the same as those shown in FIG. 1, and a description thereof is omitted as appropriate.

A communication system 100a according to the first variation includes a USB host 110, a USB device 120, and two bus relay apparatuses 200a. The bus relay apparatuses 200a are bus relay apparatuses 200 according to the first embodiment or the second embodiment. The two bus relay apparatuses 200a are provided between the USB host 110 and the USB device 120. Specifically, the USB host 110 and one (on the upstream port unit side) of the bus relay apparatuses 200a are connected via a bus 130a. This bus relay apparatus 200a (on the downstream port unit side) and the other bus relay apparatus 200a (on the upstream port unit side) are connected via a bus 132a. The other bus relay apparatus 200a (on the downstream port unit side) and the USB device 120 are connected via a bus 134a. The buses 130a, 132a and 134a are those specified by the USB standard.

FIG. 11 shows a configuration in which two bus relay apparatuses 200a are provided between the USB host 110 and the USB device 120, but there may be three or more bus relay apparatuses between the USB host 110 and the USB device 120.

According to the first variation, in addition to the effects obtained by any one of the above embodiments, the communication distance between the USB host 110 and the USB device 120 can be extended without adding any change to conventional control.

### 3.2 Second Variation

In the bus relay apparatuses 200 according to the first embodiment and the second embodiment, the arrangement of the terminals connected to the signal lines DP and DM may be configured to be capable of being changed based on the settings of a built-in control register or an external terminal (not shown).

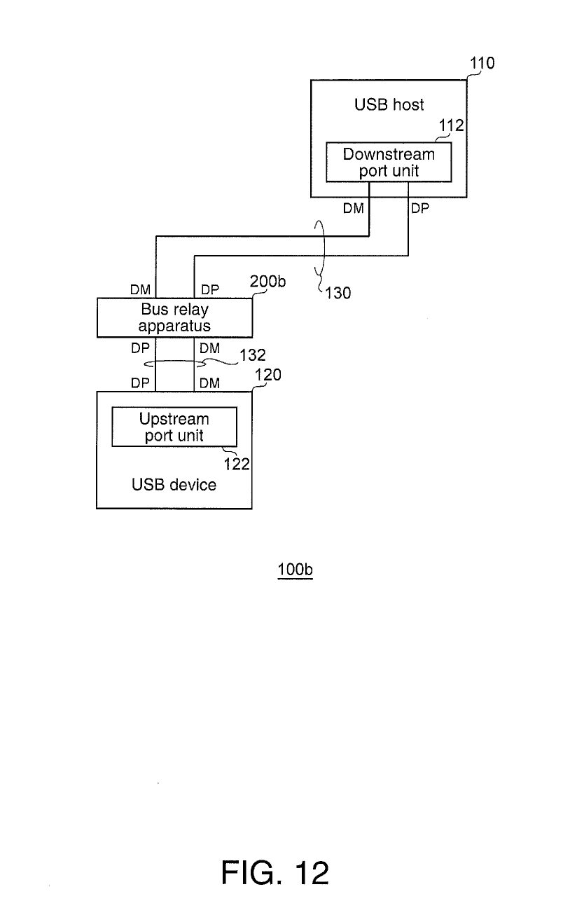

FIG. 12 shows an example of a configuration of a communication system according to a second variation of the above embodiments. In FIG. 12, the same reference numerals are given to components that are the same as those shown in FIG. 1, and a description thereof is omitted as appropriate.

In a communication system 100b according to the second variation, a bus relay apparatus 200b provided between a USB host 110 and a USB device 120 has a function of the bus relay apparatus 200 according to the first embodiment or the second embodiment. Furthermore, the bus relay apparatus 200b is configured such that in each of the upstream port unit 210 and the downstream port unit 220, two terminals connected to the signal lines DP and DM can be exchanged based on the settings of a built-in control register or an external terminal (not shown). In other words, each of the upstream port unit 210 and the downstream port unit 220 includes a first terminal and a second terminal that are arranged in a first direction. In a first operation mode, a signal of the signal line DP is input and output with respect to the first terminal, and a signal of the signal line DM is input and output with respect to the second terminal. In a second operation mode, a signal of the signal line DM is input and output with respect to the first terminal, and a signal of the signal line DP is input and output with respect to the second terminal.

For example, as shown in FIG. 12, in the bus relay apparatus 200b, the functions of the first terminal and the second terminal are exchanged between the upstream port unit side and the downstream port unit side. With this configuration, the need to provide wiring such that signal lines constituting buses connected to the first and second terminals cross with each other may be eliminated. This enables communication using USB in which noise is reduced, in addition to the effects obtained by relaying a packet or a bus status.

Cable

The bus relay apparatus according to any one of the first embodiment, the second embodiment and the variations thereof may be incorporated in a USB cable for connecting USB connectors.

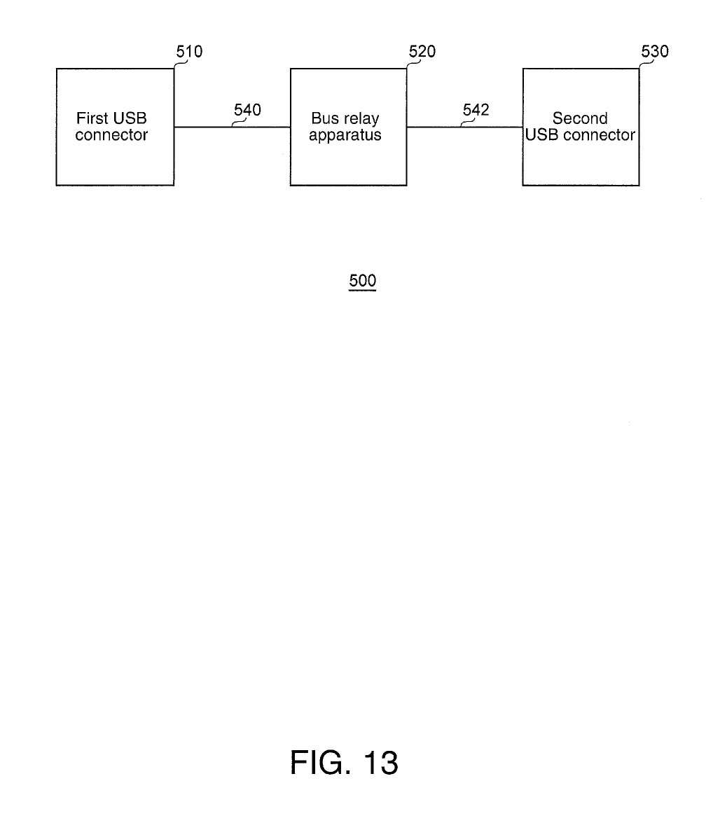

FIG. 13 is a block diagram showing an example of a configuration of a USB cable to which the bus relay apparatus according to any one of the embodiments and the variations thereof is applied.

A USB cable (“cable” in a broad sense) 500 includes a first USB connector 510 supporting the USB standard, a bus relay apparatus 520, and a second USB connector 530 supporting the USB standard. The first USB connector 510 is connected to one end of a first bus 540 supporting the USB standard. The other end of the first bus 540 is connected to one of the upstream port unit and the downstream port unit of the bus relay apparatus 520. The other of the upstream port unit and the downstream port unit of the bus relay apparatus 520 is connected to one end of a second bus 542 supporting the USB standard, and the other end of the second bus 542 is connected to the second USB connector 530.

The first USB connector 510 and the second USB connector 530 are plugs or receptacles specified by the USB standard. The first USB connector 510 and the second USB connector 530 may be, for example, standard-A plugs, standard-B plugs, mini-A plugs, mini-B plugs, standard-A receptacles, standard-B receptacles, mini-A receptacles, mini-B receptacles, or mini-AB receptacles.

The bus relay apparatus 520 is any one of the bus relay apparatuses 200 according to the first embodiment and the second embodiment and the bus relay apparatuses 200a and 200b according to the variations thereof.

With the USB cable 500 shown in FIG. 13, even in a situation where the waveform of a signal is disturbed, communication between the USB host and the USB device can be implemented by performing control in the conventional manner without providing a USB hub.

Connector

The bus relay apparatus according to any one of the first embodiment, the second embodiment and the variations thereof may be incorporated in a connector.

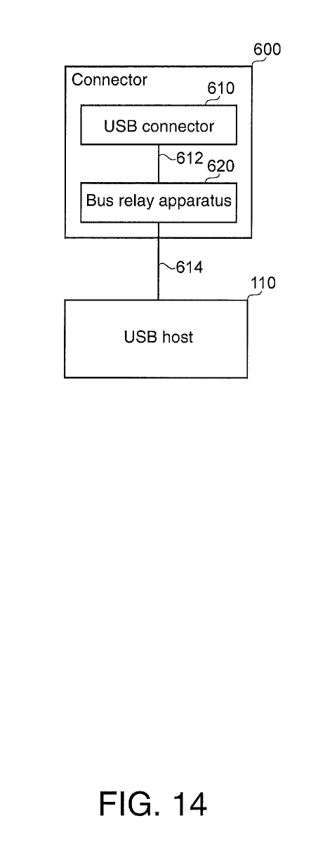

FIG. 14 is a block diagram showing an example of a configuration of a connector to which the bus relay apparatus according to any one of the embodiments and the variations thereof is applied. For example, the connector shown in FIG. 14 is incorporated in an electronic appliance or the like.

A connector 600 includes a USB connector 610 supporting the USB standard and a bus relay apparatus 620. The bus relay apparatus 620 is any one of the bus relay apparatuses 200 according to the first embodiment and the second embodiment and the bus relay apparatuses 200a and 200b according to the variations thereof. The USB connector 610 is connected to one end of a bus 612 supporting the USB standard. The other end of the bus 612 is connected to one of the upstream port unit and the downstream port unit of the bus relay apparatus 620. The USB connector 610 is a plug or a receptacle specified by the USB standard. For example, the USB connector 610 can be a standard-A plug, a standard-B plug, a mini-A plug, a mini-B plug, a standard-A receptacle, a standard-B receptacle, a mini-A receptacle, a mini-B receptacle, or a mini-AB receptacle.

For example, a USB host 110 is connected to the other of the upstream port unit and the downstream port unit of the bus relay apparatus 620 via a bus 614 supporting the USB standard. Note that a USB device 120 may be connected to the other of the upstream port unit and the downstream port unit of the bus relay apparatus 620 via the bus 614.

With the connector 600 shown in FIG. 14, even in a situation where the waveform of a signal is disturbed, communication between the USB host and the USB device can be implemented by performing control in the conventional manner without providing a USB hub.

Electronic Appliance

The bus relay apparatus according to any one of the first embodiment, the second embodiment and the variations thereof can be applied to an electronic appliance.

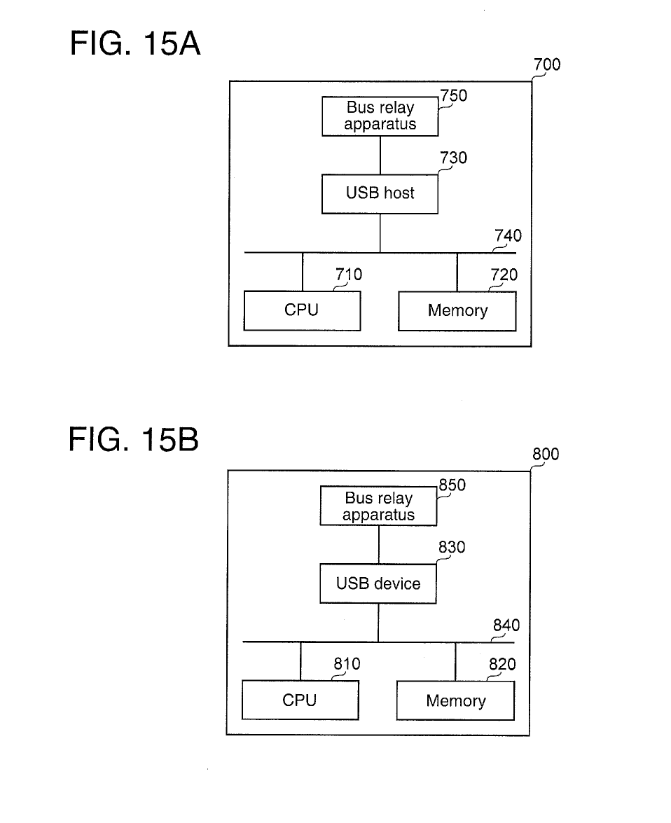

FIGS. 15A and 15B are block diagrams showing examples of configurations of electronic appliances to which the bus relay apparatus according to any one of the embodiments and variations thereof is applied.

As shown in FIG. 15A, an electronic appliance 700 having a USB host function includes a central processing unit (hereinafter referred to as a “CPU”) 710, a memory 720, a USB host 730, and a bus relay apparatus 750. The CPU 710, the memory 720 and the USB host 730 are connected via a bus 740. The memory 720 is configured by a read only memory (hereinafter referred to as a “ROM”) or a random access memory (hereinafter referred to as a “RAM”). The bus relay apparatus 750 is any one of the bus relay apparatuses 200 according to the first embodiment and the second embodiment and the bus relay apparatuses 200a and 200b according to the variations thereof. The USB host 730 is connected to an external USB device provided outside the electronic appliance 700 via the bus relay apparatus 750.

With the electronic appliance 700, the CPU 710 controls the USB host 730 by reading a program stored in advance in the memory 720 and executing processing corresponding to the program. The USB host 730 performs communication according to the USB standard with an external USB device via the bus relay apparatus 750 under control of the CPU 710.

Also, as shown in FIG. 15B, an electronic appliance 800 having a USB device function includes a CPU 810, a memory 820, a USB device 830, and a bus relay apparatus 850. The CPU 810, the memory 820 and the USB device 830 are connected via a bus 840. The memory 820 is configured by a ROM or a RAM. The bus relay apparatus 850 is any one of the bus relay apparatuses 200 according to the first embodiment and the second embodiment and the bus relay apparatuses 200a and 200b according to the variations thereof. The USB device 830 is connected to an external USB host provided outside the electronic appliance 800 via the bus relay apparatus 850.

With the electronic appliance 800, the CPU 810 controls the USB device 830 by reading a program stored in advance in the memory 820 and executing processing corresponding to the program. The USB device 830 performs communication according to the USB standard with an external USB host via the bus relay apparatus 850 under control of the CPU 810.

Examples of the electronic appliances shown in FIGS. 15A and 15B include a personal digital assistant (PDA), a digital still camera, a television receiver, a video camera, a car navigation apparatus, a pager, an electronic organizer, electronic paper, a calculator, a word processor, a work station, a video telephone, a point of sale system (POS) terminal, a printer, a scanner, a copy machine, a video player, a device equipped with a touch panel, and a device using a display panel such as a head mounted display or an electronic viewfinder.

With the electronic appliances shown in FIGS. 15A and 15B, even in a situation where the waveform of a signal is disturbed on the receiving side, communication between the USB host and the USB device can be performed with a simple configuration by performing control in the conventional manner without providing a USB hub.

The bus relay apparatus, integrated circuit apparatus, cable, connector, electronic appliance and bus relay method according to the invention have been described above by way of the above-described embodiments and variations thereof, but the invention is not limited to the embodiments and the variations thereof. For example, the invention can be carried out in various other ways without departing from the spirit and the scope of the invention, and the following modifications are also possible.

(1) The invention is not limited to the configurations, control flows and sequences of the bus relay apparatuses described in the embodiments and the variations thereof.

(2) The embodiments and the variations thereof described above have been described taking the USB 2.0 standard as an example, but the invention is not limited thereto. For example, the invention is equally applicable to a standard lower than the USB 2.0 standard, or a standard obtained by upgrading the USB 2.0 standard.

(3) In the embodiments and the variations thereof described above, the invention has been described as a bus relay apparatus, an integrated circuit apparatus, a cable, a connector, an electronic appliance and a bus relay method, but the invention is not limited thereto. For example, the invention may be a program in which the processing procedure of the bus relay method according to the invention is written, or a recording medium in which such a program is recorded.

What is claimed is:

1. A bus relay apparatus comprising:
an upstream port unit to which a USB host is connected;
a downstream port unit to which a USB device is connected;
an upstream port control unit configured to control the upstream port unit;
a downstream port control unit configured to control the downstream port unit; and
a relay unit configured to relay a packet transferred between the upstream port unit and the downstream port unit,
wherein the downstream port unit reproduces a bus status detected by the upstream port unit and transmits the bus status to the USB device, and the upstream port unit reproduces a bus status detected by the downstream port unit and transmits the bus status to the USB host.

2. The bus relay apparatus according to claim 1,
wherein a first communication speed mode is determined by a negotiation between the downstream port control unit and the USB device, and
a negotiation for establishing a connection in the first communication speed mode is executed between the upstream port control unit and the USB host.

3. The bus relay apparatus according to claim 1,
wherein the downstream port control unit knows in advance a communication speed mode of the USB host, and
it is determined, in a negotiation between the downstream port control unit and the USB device, whether or not communication can be performed in the communication speed mode of the USB host by the bus relay apparatus.

4. The bus relay apparatus according to claim 1,
wherein after the downstream port control unit has detected an attachment of the USB device to the downstream port unit, a first communication speed mode is determined by a negotiation between the upstream port control unit and the USB host, and
a negotiation for establishing a connection in the first communication speed mode is executed between the downstream port control unit and the USB device.

5. The bus relay apparatus according to claim 1,
wherein the upstream port control unit knows in advance a communication speed mode of the USB device, and
it is determined, in a negotiation between the upstream port control unit and the USB host, whether or not communication can be performed in the communication speed mode of the USB device by the bus relay apparatus.

6. The bus relay apparatus according to claim 1,
wherein the relay unit transmits a signal corresponding to the packet relayed between the upstream port unit and the downstream port unit.

7. An integrated circuit apparatus comprising:
the bus relay apparatus according to claim 2; and
the USB host that is connected to the upstream port unit.

8. An integrated circuit apparatus comprising:
the bus relay apparatus according to claim 3; and
the USB host that is connected to the upstream port unit.

9. An integrated circuit apparatus comprising:
the bus relay apparatus according to claim 4; and
the USB device that is connected to the downstream port unit.

10. An integrated circuit apparatus comprising:
the bus relay apparatus according to claim 5; and
the USB device that is connected to the downstream port unit.

11. A cable comprising:
a first USB connector;
a first bus to which the first USB connector is connected at one end thereof;
the bus relay apparatus according to claim 1 whose upstream port unit is connected to the other end of the first bus;
a second bus to which the downstream port unit is connected at one end thereof; and
a second USB connector that is connected to the other end of the second bus.

12. A connector comprising:
a USB connector; and
the bus relay apparatus according to claim 1 whose upstream port unit or downstream port unit is connected to the USB connector.

13. An electronic appliance comprising the bus relay apparatus according to claim 1.

14. A bus relay method performed between an upstream port unit to which a USB host is connected and a downstream port unit to which a USB device is connected, the bus relay method comprising:
a first performing a negotiation with the USB device according to a communication speed mode with the USB host;
a second performing a negotiation with the USB host after the first connection step; and
a relaying a packet or a bus status between the upstream port unit and the downstream port unit after the second connection step.

15. A bus relay method performed between an upstream port unit to which a USB host is connected and a downstream port unit to which a USB device is connected, the bus relay method comprising:
a detecting an attachment of the USB device to the downstream port unit;
a first performing a negotiation with the USB host according to a communication speed mode with the USB device after the detection step;
a second performing a negotiation with the USB device after the first connection step; and
a relaying a packet or a bus status between the upstream port unit and the downstream port unit after the second connection step.

16. The bus relay method according to claim 12,
wherein in the relay step, a bus status generated by one of the upstream port unit and the downstream port unit is reproduced and transmitted by the other port unit, and
a signal corresponding to the packet relayed between the upstream port unit and the downstream port unit is transmitted.
